(19) United States
(12) Patent Application Publication
(10) Pub. No.: US 2006/0259952 A1
(43) Pub. Date: Nov. 16, 2006

(54) Unified roaming profile network provisioning system

(76) Inventor: Simon Lok, Vero Beach, FL (US)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 11/432,698

(22) Filed: May 10, 2006

Related U.S. Application Data
(60) Provisional application No. 60/594,883, filed on May 16, 2005.

(51) Int. Cl. H04L 9/00

(52) U.S. Cl. 726/1

(57) ABSTRACT

A method of network provisioning where a profile is associated with a specific end-user node and policies are enforced via a unified network provisioning appliance. Unlike traditional back-ends where multiple discrete devices are deployed to provision a network, the present invention can be implemented as a single unified device with all of the functionality implemented as software plug-ins. In accordance with embodiments of the present invention, features execute on the same device and share a common provisioning profile. Hence, the present invention features unbounded interoperability between what are normally considered separate sets of functionality. This capability allows provisioning services such as bandwidth shaping, identity manager, content filter and the like to enforce policies that are defined for the user of a node. Furthermore, our system is capable of dynamically changing policies enforced on a node to reflect a change in the user who is operating the node.

This application claims the benefit of U.S. Provisional Patent Application Ser. No. 60/594,883 filed on May 16, 2005, the specification of which is incorporated herein by reference.

### FIELD OF THE INVENTION

The present invention relates, in general, to network data communications, and, more particularly, to software, systems and methods for providing unified roaming profile for resource provisioning in a networked computer system.

### RELEVANT BACKGROUND

A networked computer system comprises a plurality of user or client nodes and a plurality of network service and or resource nodes that provide various services (e.g., software applications, bandwidth management, database access, data storage access, printer access, Internet connectivity access, and the like). In early, simple networked computer systems all network-attached users were allowed to connect to and access all network-attached servers and resources. Early on, however, network administrators recognized the need to restrict access to network resources and servers based on particular user needs or roles in which the user acted. The term “network provisioning” refers to processes that enable access to network services in a manner that complies with established usage policies that define which resources and services each user is able to access.

In a typical network provisioning backend, there are a number of discrete systems that are chained together, each providing a particular function. For example, an identity management system determines that a particular node is permitted to access the network, a firewall enforces a packet filtering policy, a bandwidth shaper enforces a usage and prioritization policy, etc. Typically, the assumption is that the end user will always be using the same node. Policies are therefore enforced upon a particular node. For example, a public kiosk is permitted by the identity management system to access the internet and public corporate web server but not other sensitive corporate infrastructure. Conversely, the desktop in the corporate executive's office may be granted full access to all network resources.

The current methodology assumes that a network address and an end user are equivalent. However, a network node may be used by individuals with very different needs and privileges at different times. For example, in a University setting, one will often find a shared bank of computers. A student should have limited bandwidth, low priority and only be allowed access to certain sites whereas a professor will have no restrictions on bandwidth or reach-ability and a higher priority.

These problems are further exacerbated when wireless networks are deployed. Network addresses, such as an IP address, are assigned to a network interface of a particular machine. In wireless networks the address assignment is particularly volatile as the address assignment is often handled by one of several gateway devices that provide wireless connectivity. Since each gateway device may have its own pool of addresses available for assignment, multiple users may have the same network address. Moreover, machine addresses change more frequently as a machine moves from one gateway device to another.

In many cases a wireless network supports both corporate employees as well as guests. Ideally, corporate employees would have more network access privileges than guests. However, current wireless networking paradigms do not easily facilitate this possibility. A network administrator could choose to deploy twice the number of radios (e.g., gateway devices) to create separate wireless segments, but this would cost at least twice as much and only support two access profiles. Furthermore, the limited frequency spectrum available to wireless networks becomes an issue because overlapping wireless segments must operate on different frequencies.

One approach to solving this problem is to deploy software on all network-connected nodes that enforces a roaming network profile. Some of this functionality is already incorporated into Windows 2000 and XP. However, this approach is incapable of supporting guests because it cannot be guaranteed that guests will have the proper software installed, and even if they do, the software needs to be configured to trust a corporate domain controller. Furthermore, since this approach centers on deploying software that executes on the network node, it is much easier to subvert than a centralized network provisioning system that executes on devices stored in the network closet.

### SUMMARY OF THE INVENTION

Briefly stated, the present invention involves a method of network provisioning where a profile is associated with a specific end-user node and policies are enforced via a unified network provisioning appliance. Unlike traditional back-ends where multiple discrete devices are deployed to provision a network, the present invention can be implemented as a single unified device with all of the functionality implemented as software plug-ins. In accordance with embodiments of the present invention, features execute on the same device and share a common provisioning profile. Hence, the present invention features unbounded interoperability between what are normally considered separate sets of functionality. This capability allows provisioning services such as bandwidth shaping, identity manager, content filter and the like to enforce policies that are defined for the user of a node. Furthermore, our system is capable of dynamically changing policies enforced on a node to reflect a change in the user who is operating the node.

### BRIEF DESCRIPTION OF THE DRAWINGS

FIG. 1 shows a typical prior art Network Provisioning Device Stack;

FIG. 2 shows an independent Policy Network Provisioning Architecture in accordance with the present invention;

FIG. 3 illustrates a unified Policy Network Provisioning Architecture in accordance with the present invention; and;

FIG. 4 shows role-based policy assignment (RBPA) in accordance with the present invention.

### DETAILED DESCRIPTION OF THE PREFERRED EMBODIMENTS

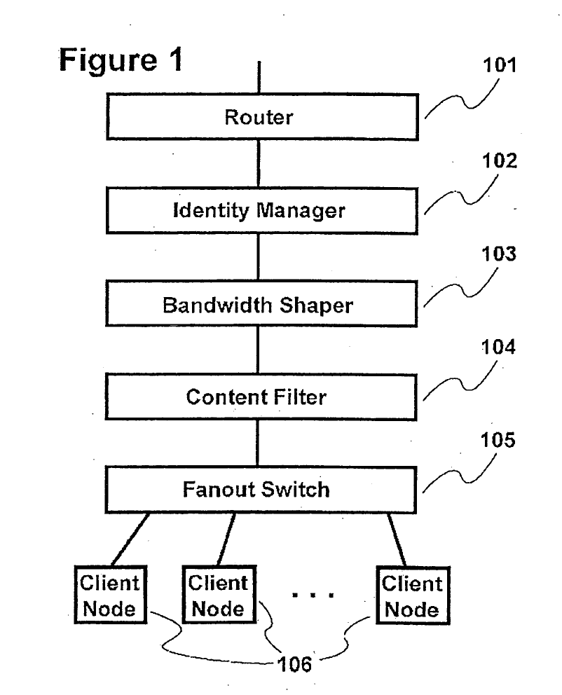

Referring to FIG. 1, most network provisioning occurs at the border between the network uplink and the clients (106). A typical system includes at least an identity manager (102), bandwidth shaper (103) and content filter (104) between the router (101) and a fanout switch (105). In a typical network closet as shown in FIG. 1, there is a stack of network provisioning equipment to enforce administrator defined policies at the border between the uplink and the local area network. At the very least one would expect to find an identity manager, bandwidth shaper and content filter. Additional provisioning devices might include, but would not be limited to, packet filters (firewalls), intrusion detection/protection systems and proxy gateways for common services, including, but not limited to, email, WWW and instant messaging.

To provision a network, the administrator defines a policy for each device that is relevant to the enforcement mechanism implemented by that device. Typically, each enforcement device is self-contained and serves a single purpose. In a typical multi-device network provisioning architectures, the identity manager is responsible for validating whether or not a particular node possesses the proper user credentials for network access. Using this information, the identity manager will then enforce a simple network access policy (e.g., if the node presents valid user credentials, then permit network traffic to and from the node).

Similarly, the bandwidth manager is responsible for enforcing traffic limitation and prioritization on particular nodes. The users do not log into the bandwidth manager individually, hence, the bandwidth manager has no knowledge of a particular user's credentials. Since the bandwidth manager has no knowledge or capabilities with respect to the user credentials that a node may have presented to the identity manager, the bandwidth policy is statically defined and enforced on a particular node or a network of nodes.

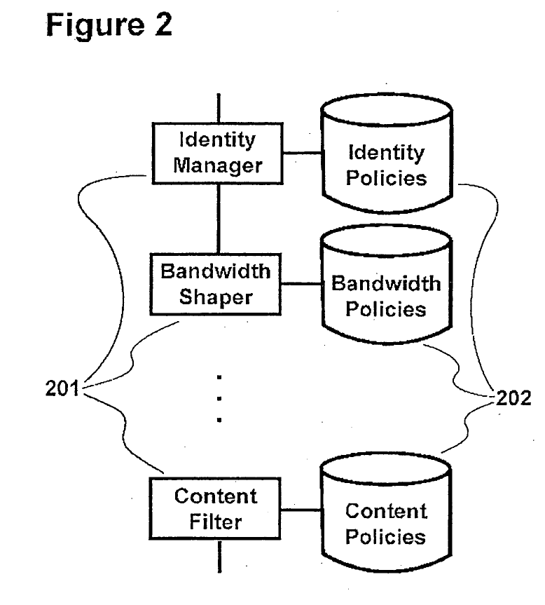

The reason for this disconnect is that policy definition and storage for a particular device is unique to that device, as shown in FIG. 2. FIG. 2 shows an independent Policy Network Provisioning Architecture. In FIG. 2 a series of policy enforcement devices (201) are daisy chained. Each of the devices will typically have its own independent policy database (202). The lack of inter-device integration is not necessarily by design as much as by necessity, as only IP packets in wire format are typically shared between devices. Thus there is no meta-information interface between any two devices. Although it would be theoretically possible to standardize on a meta-data format to facilitate inter-device policies, this has not happened in the industry as it is a non-trivial engineering task and requires the support of a wide range of vendors. Moreover, even if standard meta-data formats were defined, exchanging information would require communication interfaces and protocols between the various provisioning devices which could create significant communication overhead and impact system performance.

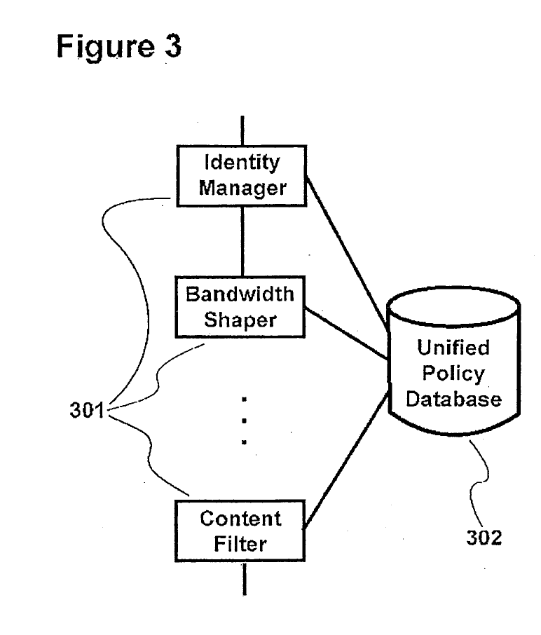

The present invention provides a unified, centrally stored, policy database to drive the network provisioning functionality, as shown in FIG. 3. In order to satisfy the needs of each of the provisioning devices, unified policy database 302 supports the union of all attributes needed to drive each function individually. By unifying the policy database, the present invention also unifies the node meta-data and thus each policy enforcement engine has full knowledge of all provisioning operations performed by the other engines. Unified policy database 302 may be implemented using available relational database engines (e.g., SQL-based RDBMS, and the like), as a directory structure, as a directory service (e.g., LDAP, NIS and the like) or a meta-directory structure that unifies several underlying directory structures or databases.

FIG. 3 illustrates a Unified Policy Network Provisioning Architecture in accordance with an embodiment of the present invention. A set of policy enforcement engines 301 draws upon a unified policy database 302 that supports the union of all attributes needed for complete network provisioning. A unified database allows meta-data to be shared between the policy enforcement engines 301. Shared meta-data empowers the system to dynamically enforce comprehensive provisioning profiles based on the actual user of a node rather than a network address.

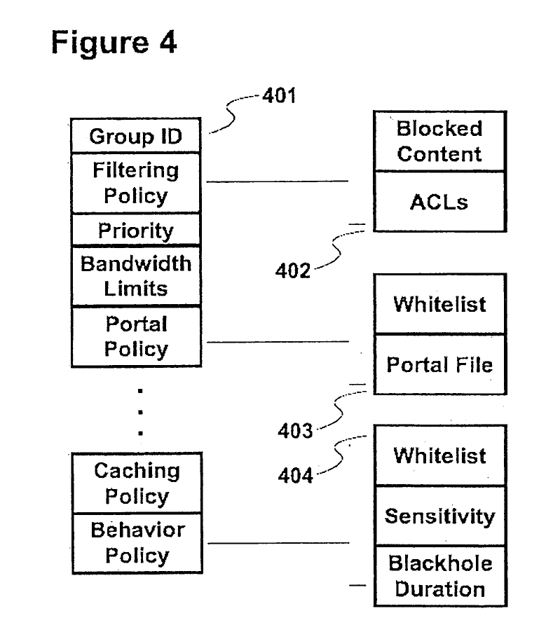

The present invention may be implemented using role-based policy assignment (RBPA) as shown in FIG. 4. Hence the records in the policy database are organized by group, where each group represents a role. Groups may contain one or more users as well as lists of IP or MAC addresses. Each group contains a series of entries to define provisioning policies, including, but not limited to, filtering, bandwidth, priority, packet capture, caching and behavior. FIG. 4 illustrates a typical entry in our unified policy database. The core of the entry is clustered by the unique group identifier (401) and consists of a set of references to policies, including, but not limited to, filtering (402), captive portal (403) and behavior (404).

By having a single, unified and shared policy database 302 from which multiple network provisioning tasks are accomplished, policies can be dynamically enforced on users rather than on nodes. To accomplish this, the packet header information is passed to a role-based policy assignment engine (303) which returns the complete policy set for the role associated with a packet. Thus, the individual policy enforcement engines have global knowledge about the role of the user present at a node and can dynamically alter policy enforcement for a particular role rather than being statically defined and enforced on the node or the network.

For example, if a corporate executive logs in at a shared workstation in a lounge, the network provisioning backend can automatically allocate more bandwidth at a higher priority to that workstation than if a junior staffer sat at the very same workstation at a later time. Similarly, the content filtering system could provision unfettered access to websites with frivolous content to the members of the marketing department, but other users of the shared workstation are simply directed to a page stating that viewing of frivolous content is prohibited.

Other unique interactions between aspects of provisioning are also possible. The bandwidth manager can automatically grant high priority to connections determined to be VoIP sessions by the network instrumentation of the intrusion detector. The transparent web cache can decide to not cache data from a node that is connected via an IPsec VPN session. By unifying the policy database and sharing meta-data between network provisioning functionality, the present invention provides a provisioning architecture with unique capabilities that are otherwise not possible.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A method of network provisioning
creating a profile associated with a specific end-user node;
providing a unified network provisioning appliance containing a plurality of profiles; enforcing policies in each of a plurality of network provisioning components by causing each of the network provisioning components to access the unified network provisioning device to access a selected profile that is appropriate for a particular network communication.

2. The method of claim 1 wherein the unified network provisioning appliance comprises a single unified device having a pluggable interface for communicating with network provisioning components.

3. The method of claim 2 wherein the functionality of at least one provisioning component is implemented as a software plug-in coupled to the pluggable interface.

4. The method of claim 1 wherein at least one of the plurality of network provisioning components implements bandwidth shaping to enforce policies that are defined for the user of a node.

5. The method of claim 1 wherein at least one of the plurality of network provisioning components implements identity manager to enforce policies that are defined for a user of the node.

6. The method of claim 1 wherein at least one of the plurality of network provisioning components implements content filter to enforce policies that are defined for a user of the node.

7. The method of claim 1 further comprising dynamically changing policies enforced on a node to reflect a change in a user who is operating the node.

8. A network provisioning appliance comprising:
a unified policy database comprising a plurality of records, wherein each record contains attributes defining a use policy for an associated user; and
an interface for coupling to a plurality of provisioning components, wherein the interface is configured to enable each provisioning component to access the unified policy database.

9. The network provisioning appliance of claim 8 wherein the interface comprises a pluggable interface that is common for a disparate set of provisioning components.

10. The network provisioning appliance of claim 9 wherein the disparate set of provisioning components are implemented as separate processes executing on a single computing platform.

11. The network provisioning appliance of claim 10 wherein at least one of the plurality of network provisioning components implements bandwidth shaping to enforce policies that are defined for the user of a node.

12. The network provisioning appliance of claim 10 wherein at least one of the plurality of network provisioning components implements identity manager to enforce policies that are defined for the user of a node.

13. The network provisioning appliance of claim 10 wherein at least one of the plurality of network provisioning components implements content filter to enforce policies that are defined for the user of a node.

14. The network provisioning appliance of claim 10 further comprising dynamically changing policies enforced on a node to reflect a change in the user who is operating the node.

15. A data structure comprising:
a plurality of policy records wherein each record contains attributes defining a use policy for an associated user; and
an interface allowing multiple disparate provisioning components to have access to the policy records.
